(19) United States
(12) Patent Application Publication
(10) Pub. No.: US 2010/0092646 A1
(43) Pub. Date: Apr. 15, 2010

(54) BROWNED BUTTER PRODUCT AND METHOD OF MAKING THE SAME

(76) Inventor: Kelly B. Krauss, Clinton, NJ (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/250,972

(22) Filed: Oct. 14, 2008

(51) Int. Cl. A23C 15/12; A23C 15/02

(52) U.S. Cl. 426/581; 426/417

(57) ABSTRACT

A method of enhancing a butter product involves removing all of all, or at least most of, the water content from butter leaving mainly clarified butter and milk solids. The milk solids in the clarified butter are browned and then the milk solids and the clarified butter are cooled. The clarified butter and browned milk solids are agitated once cooled to attain at least, generally uniform consistency. The product is then solidified and packaged. In some forms, an additive can be introduced into the product, preferably before the agitation step. Such additive can include a bulking agent (e.g., safflower oil) and/or a flavor enhancement (e.g., lemon zest).

### BACKGROUND OF THE INVENTION

1. Field of the Invention

The present invention relates generally to a comestible product and a method for producing the same. Some embodiments of the invention relate to a solidified, rehydrated or non-rehydrated browned butter product and some embodiments relate to methods for producing a solidified non-rehydrated browned butter product or a solidified re-hydrated browned butter product. Additionally, some embodiments of the invention relate to a dehydrated brown butter product and methods for making the same.

2. Description of the Related Art

Browned butter has long been a staple of fine restaurants and experienced chefs the world over. It is well known among chefs and cooks (as well as “foodies” or gourmands) that browned butter makes foods and sauces richer and more complex. Browned butter is butter that is heated until all, or substantially all, of the water content of the butter evaporates and the milk solids begin to slightly brown or caramelize. The problem with browned butter is that it can be challenging to make. The chef or cook must use moderate heat, stir constantly and have an eye for the perfect color or browning. If the butter is not browned enough, the flavor will be too mild. If the butter is overbrowned or burnt it will be bitter and inedible. The chef must therefore precisely gauge when the butter has reached its optimal flavor potential, remove it from the heat and stop the cooking before it burns. This is a challenging task to master for the everyday home cook, and can test event the most seasoned professional chef.

The flavor of browned butter compliments and enhances almost any food and/or food product. When it comes to baked goods, however, incorporating browned butter as a substitute for fresh sweet butter can be problematic. If the browned butter is still in its liquid form it can be oily or greasy anti, ultimately, will not behave in the same way typical solid butter would behave in a baking recipe. Further, even re-solidified browned butter (by a reduction in temperature) will not behave in the same way as fresh solid sweet butter. The browning process boils off all, or it least a substantial portion, of the water in sweet butter (approximately 19% of fresh sweet butter is water) before browning the milk solids. Adding browned butter in place of fresh sweet butter produces drier and more crumbly baked goods because you are essentially adding less liquid to a batter or dough.

### SUMMARY OF THE INVENTION

An aspect of the present invention involves the recognition that transforming browned butter into a product that can be substituted for regular butter in baking recipes would make browned butter readily and easily accessible to home cooks and professional chefs alike. This document thus describes a method for making a re-hydrated browned butter product that mimics the behavior or properties of fresh sweet butter in baked goods. In addition, because browned butter without rehydration is desirable for some applications (in sauces or to flavor cooked foods, for example), there is also provided a method for re-solidifying non-rehydrated browned butter so it can be offered to the consumer in a usable solidified and generally homogeneous form.

One aspect of the present invention relates to a method for producing a browned butter product. The method involves beating butter to and maintaining it at a boiling point, until all, or at least a substantial portion, of the water content is evaporated. The butter is then heated further (e.g., the same heat is maintained) until the milk solids in the butter caramelize and brown. Once browned, the butter is cooled and then whipped or beaten to re-emulsifying the butter into a generally homogeneous mixture.

Another aspect of the present invention involves a product made by the above-described process.

An additional aspect of the present invention involves a product made by the process of removing all, or at least a substantial portion, of the water content of butter, and heating (e.g., cooking) the butter until the milk solids in the butter are caramelized or browned. A generally bland liquid (such as, for example, but without limitation, water, cream, milk, buttermilk or whole sweet butter) is introduced to the browned butter, the mixture is cooled, and the browned butter and the added liquid are mixed (e.g., beaten or whipped) to re-emulsify the browned butter product into a generally homogeneous mixture.

A further aspect of the present invention involves a product made by the process of removing all, or at least a substantial portion, of the water content of the butter, and heating (e.g., cooking) the butter until the milk solids in the butter are caramelized or browned. A flavored liquid (such as, for example, but without limitation, flavored liquor, fruit juice and/or zest, flavored oil or flavor extract) is added to the browned butter, the mixture is cooled, and the browned butter and the added flavorings are mixed (e.g., beaten or whipped) to re-emulsify the browned butter product into a generally homogeneous mixture.

An additional aspect of the present invention involves a packaged enhanced product prepared by the steps of:

removing all, or at least most of, the water content from butter leaving mainly clarified butter and milk solids;

browning the milk solids;

cooling the clarified butter and browned milk solids;

agitating the clarified butter and browned milk solids to produce a product having at least a generally uniform consistency;

solidifying the product; and

packaging the product.

A further aspect of the present invention involves a method of enhancing a butter product comprising removing all, or at least most of, the water content from the butter leaving mainly clarified butter and milk solids. The milk solids, in the clarified butter, are browned and cooled. The clarified butter and milk solids are agitated to attain at least a generally uniform consistency. In some embodiments, a flavor enhancing element and/or a bulking agent can be added. Such additives are preferably introduced at least before the agitating step. In some embodiments, the end product is packaged after being solidified.

### BRIEF DESCRIPTION OF THE DRAWINGS

The above mentioned and other features of the invention will mow be described with reference to the drawings of several embodiments of methods for producing a browned butter product and of browned butter products. The illustrated embodiments are intended to illustrate, but not to limit the invention. The drawings contain the following figures:

FIG. 1 illustrates in perspective view of a non-rehydrated browned butter product made in accordance with a preferred embodiment of the present invention.

FIG. 2 illustrated in perspective view a rehydrated re-emulsified browned butter product made in accordance with another preferred embodiment of the present invention.

FIG. 3 illustrated in perspective view browned butter product in a powder form that is made in accordance with an additional embodiment of the present invention.

FIG. 4 is a flow chart describing the steps of a preferred embodiment of a method of making a non-rehydrated browned butter product.

FIG. 5 is a flow chart describing the steps of another preferred embodiment of a method of making another embodiment of a non-rehydrated browned butter product.

FIG. 6 is a flow chart describing the steps of a preferred embodiment of a method of making a rehydrated browned butter product.

FIG. 7 is a flow chart describing the steps of a preferred embodiment of a method of making another embodiment of a rehydrated browned butter product.

FIG. 8 is flow chart describing the method of making another embodiment of a browned butter product.

### DETAILED DESCRIPTION OF THE PREFERRED EMBODIMENTS

The following detailed description should be read with reference to the drawings, in which like elements in different drawings are identically numbered. The drawings, which are not necessarily to scale, depict selected embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

While the examples provided herein are discussed with respect to standard American styled butter (e.g., sweet cream butter), it should be appreciated that the embodiments described herein could be used for other types of butters or similar dairy-based products, such as, for example, but without limitation, French styled cultured butter, sheep's milk butter, buffalo's milks butter, goat's milk butter or yak's milk butter. Additionally, the butter can be cultured, pasteurized or raw (flesh and unpasteurized), can be salted (or otherwise seasoned) or unsalted (or unseasoned), and can be modified (e.g., by incorporating vegetable and or nut oils) or unmodified.

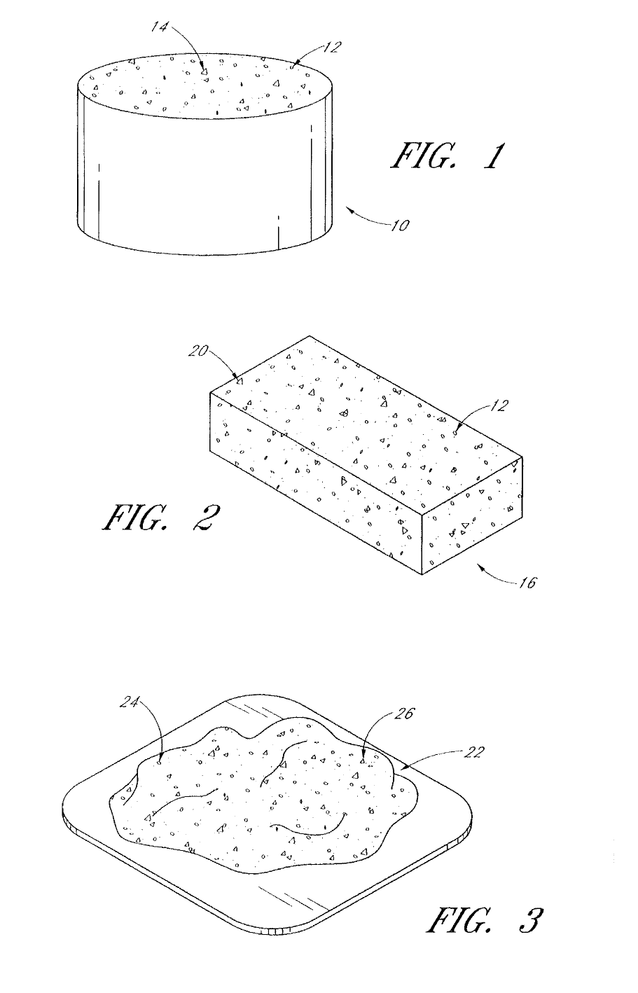

With reference now to FIG. 1, one embodiment of a mixed browned butter product 10 is illustrated. Browned butter product 10 includes browned milk solids 12. This embodiment also includes particles of a flavor enhancing agent 14. The degree of browning of the milk solids is variable and will determine the amount or strength of flavor imparted to the browned butter product. For example, lightly browned milk solids—sometimes referred to as beurre noisette—will be slightly browned so that the butter develops a nutty aroma and flavor. Another example for more darkly browned milk solids—sometimes referred to as beurre noir (“black” butter)—would involve browning the milk solids to a deeper and darker color thereby increasing the intensity of the flavor.

FIG. 2 illustrates another embodiment of a product make by one of the disclosed methods. FIG. 2 illustrates a solid rehydrated and re-emulsified product 16. This product 16 also contains browned milk solids 18 and flavor enhancements 20. Not shown, although intended to be within the scope of the invention, is a re-emulsified product without flavor enhancements.

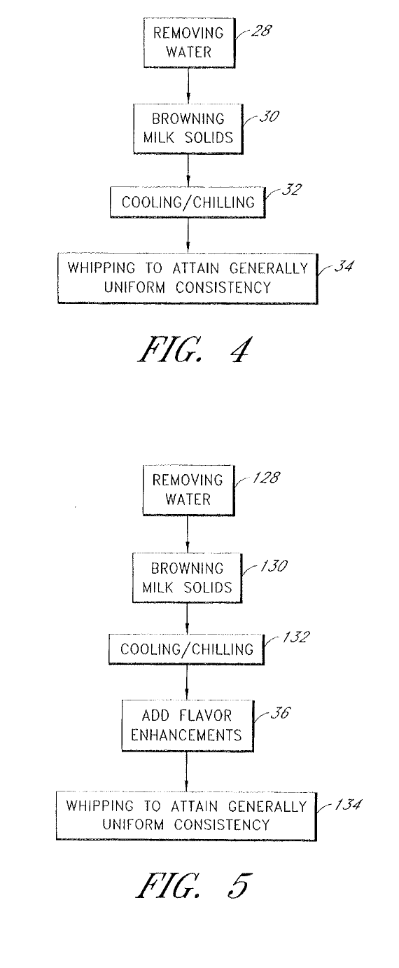

FIG. 3 illustrates yet another embodiment of the invention. The product 22 is powdered browned milk solids. The embodiment shows particles of browned milk solids 24 as well as powdered flavor enhancements 26. Although powdered product 22 contain flavor enhancements 26, the invention will also include powdered browned milk solids without any flavor enhancements.

FIG. 4 illustrates an embodiment of a preferred method for making a non-rehydrated browned butter product. Step 28 involves removing all, or at least a substantial portion, of the water from the fresh sweet butter. One method of removing the water from the fresh sweet butter is to heat the fresh sweet butter at a moderate temperature. This moderate temperature can be in the range of 200-212 degrees Fahrenheit. This can be a time consuming process, depending on how much butter is being browned. For example, this process can take seven to ten minutes for a quarter of a pound of fresh sweet butter. The practitioner may also remove the water by any other method as would be known by a person of skill in the art. Clarified butter is liquid butter remaining after the water is boiled off. Once all, or at least most of, the water has been removed, the remaining product, comprising clarified butter and milk solids, is further processed.

Step 30 involves browning the milk solids in the clarified butter. The preferred method for browning the milk solids is to heat the dehydrated fresh sweet butter at the same low temperature range of 200-212 degrees Fahrenheit. The browning process is preferably continued until the milk solids turn a hazelnut color. Tile range of temperature listed above is used for example purposes and are not meant to limit the invention in any manlier. Further, the amount of browning is similarly not meant to limit the invention in any manner. Browning the milk solids to lighter and darker color will provide a variety of different tasting products suitable for various uses.

Step 32 describes a cooling process. This can be accomplished by allowing the browned milk solids to rest at room temperature. Other examples or suitable cooling processes would be to place the browned milk solids into a reduced temperature environment (e.g., within a refrigerator, a freezing unit, or a cellar). Typically, the browned milk solids should be cooled until the substance solidifies. This is typically in the range of sixty to seventy degrees Fahrenheit for sweet cream butter. The range of temperature listed above is used for example purposes only and are not meant to limit the invention in any manner.

Step 34 involves whipping or agitating the browned milk solid with the clarified butter to for a generally uniform texture. This process can be typically done with a mixer or other similar device. The process can be done at a speed that aerates the butter and can take about three to four minutes. The end product is then refrigerated. The end product can be also be separated into conventional butter sticks or any other size that is desired.

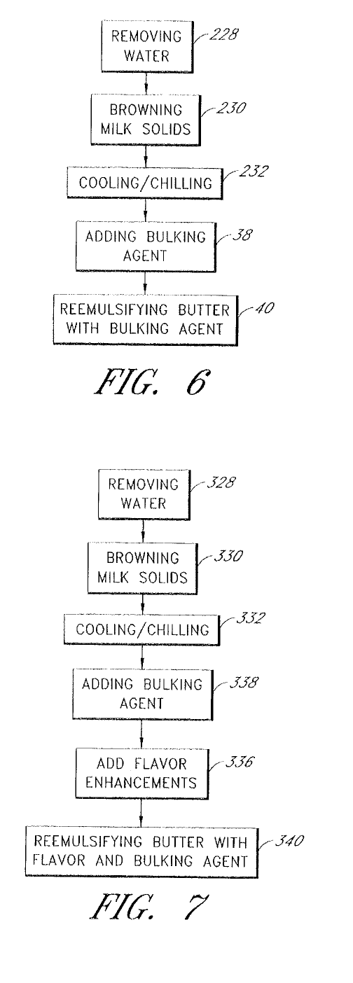

FIG. 5 illustrates another embodiment of a preferred method for making a non-rehydrated browned butter product. Steps 128; 130; 132; and 134 are analogous to steps 28; 30; 32 and 34 described in FIG. 4. The additional step 36 is used to add one or more flavor enhancing elements to the clarified butter and browned milk solids. Examples of flavor, enhancing elements include but are not limited to: lemon zest; orange zest, lime zest; herbs; spices; or seasonings. Typically, these flavor enhancements would be mixed into the product in a generally uniform manner.

FIG. 6 illustrates an embodiment of a preferred method for making a rehydrated browned butter product. Steps 228; 230; and 232 are analogous to steps 28; 30 and 32 respectively. Step 38 involves adding one or more bulking agents to the clarified butter and browned milk solids. Examples of acceptable bulking agent include but are not limited to: cold whole butter; canola oil; safflower oil; grapeseed oil; walnut oil; almond oil; pecan oil; macadamia nut oil; solid shortening; rendered bacon, duck fat; water; milk; cream; buttermilk; crème fraiche; orange juice; lemon juice; lime juice; Grand Marenier; kalua; rum; gin; schnapps; maple syrup; honey; and flavored abstracts such as vanilla or almond.

Step 40 involves re-emulsifying the browned milk solids with the bulking agent. The re-emulsification is typically accomplished by whipping the browned milk solids with the bulking agent to form a generally uniform emulsified substance.

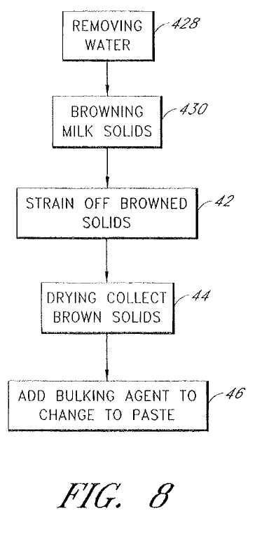

FIG. 7 illustrates another embodiment of a preferred method for making a rehydrated browned butter product: In this embodiment, both a bulking agent and one or more flavor enhancements are added to the browned milk solids. Steps 328; 330; 332; 336; 338; and 340 are analogous to steps 28; 30; 32; 36; 38 and 40 respectively.

FIG. 8 illustrates an exemplary method for making a dehydrated browned butter product, such as for example the product illustrated in FIG. 3. The steps disclosed in 428 and 430 are analogous to steps 28 and 30 respectively. Step 42 involves separating the browned milk solids from the clarified butter. This separating can be accomplished with a fine filter or mesh or other separating techniques known in the art. Step 44 involves drying the browned milk solids so that they can be ground, crushed or otherwise reduced into a powder form. The powdered browned milk solids could also me added with one or more flavoring enhancements or bulking agents.

This invention has been described and specific examples of the invention have been portrayed. While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

What is claimed is:

1. A packaged enhanced butter product prepared by the steps of:
removing all, or at least most of, the water content from butter leaving mainly clarified butter and milk solids;
browning the milk solids;
cooling the clarified butter and browned milk solids;
agitating the clarified butter and browned milk solids to produce a product having at least a generally uniform consistency;
solidifying the product; and
packaging the product.

2. The enhanced butter product of claim 1 prepared by the additional step of adding at least one flavor enhancement to the clarified butter.

3. The enhanced butter product of claim 2, wherein the flavor enhancement is added to the clarified butter before the clarified butter is agitated.

4. A method of enhancing a butter product comprising:
Removing all, or at least most of, the water content from butter leaving mainly clarified butter and milk solids;
browning the milk solids;
cooling the clarified butter and browned milk solids; and
agitating the clarified butter and browned milk solids to attain at least a generally uniform consistency.

5. The method of claim 4 additionally comprising the adding at least one flavor enhancement to the clarified butter.

6. The method of claim 5, wherein the flavor enhancement is added to the clarified butter before the clarified butter is agitated.

7. An enhanced butter product prepared by the steps of;
Removing all, or at least most of, the water content from butter leaving mainly clarified butter and milk solids;
browning the milk solids;
cooling the clarified butter and browned milk solids;
adding a bulking agent to the clarified butter and milk solids; and
agitating the clarified butter and browned milk solids and bulking agent to attain at least a generally uniform consistency.

8. The enhanced butter product of claim 7 prepared by the additional step of adding a flavor enhancement.

9. A method of enhancing a butter product comprising:
removing all, or at least most of, the water content from butter leaving mainly clarified butter and milk solids;
browning the milk solids;
cooling the clarified butter and browned milk solids;
adding a bulking agent to the clarified butter and milk solids; and
agitating the clarified butter and browned milk solids and bulking agent to attain at least a generally uniform consistency.

10. The method of claim 9 additionally comprising the step of adding at least one flavor enhancement.

11. A packaged enhanced butter product prepared by the steps of:
removing substantially all of the water content from butter leaving mainly clarified butter and milk solids;
browning the milk solids;
cooling the clarified butter and browned milk solids;
agitating the clarified butter and browned milk solids to produce a product having at least a generally uniform consistency;
solidifying the product; and
packaging the product.

12. An enhanced butter product prepared by the steps of;
removing substantially all of the water content from butter leaving mainly clarified butter and milk solids;
browning the milk solids;
cooling the clarified butter and browned milk solids;
adding a bulking agent to the clarified butter and milk solids; and
agitating the clarified butter and browned milk solids and bulking agent to attain at least a generally uniform consistency.
